(19) United States
(12) Patent Application Publication
(10) Pub. No.: US 2024/0323208 A1
(43) Pub. Date: Sep. 26, 2024

(54) SYSTEMS AND METHODS FOR DETECTING ANOMALOUS BEHAVIOR IN INTERNET-OF-THINGS (IOT) DEVICES

(71) Applicant: Acronis International GmbH, Schaffhausen (CH)

(72) Inventors: Dinil Mon Divakaran, Singapore (SG); Philipp Gysel, Bern (CH); Candid Wüest, Bassersdorf (CH); Serg Bell, Costa Del Sol (SG); Stanislav Protasov, Singapore (SG)

(21) Appl. No.: 18/186,381

(22) Filed: Mar. 20, 2023

(51) Int. Cl. H04L 9/40

(52) U.S. Cl. CPC H04L 63/1425; H04L 63/1416; H04L 63/1441

(57) ABSTRACT

Disclosed herein are systems and methods for detecting anomalous behavior (e.g., attacks) in devices within a network. In an exemplary aspect, a method includes intercepting a first plurality of packets being transmitted in a network with a plurality of devices; identifying, from the first plurality of packets, a subset of packets corresponding to a device of the network; extracting a plurality of deterministic features from the subset of packets; calculating, based on the subset of packets, a risk score associated with the device based on a deviation of the features from a deterministic profile of the device, a first probability of the subset of packets exhibiting anomalous behavior based on a per-device model, and a second probability of the plurality of packets exhibiting anomalous behavior based on a network model; classifying anomalies into attack categories, and executing a remediation action to resolve anomalous behavior in the device.

### FIELD OF TECHNOLOGY

The present disclosure relates to the field of cybersecurity, and, more specifically, to systems and methods for detecting anomalous behavior in Internet-of-Things (IoT) devices using deterministic profiling and machine learning.

### BACKGROUND

Offices, homes, enterprises, and different industry verticals today have numerous Internet-of-Things (IoT) devices connected to their networks. Example devices include smart thermostats, hubs, lighting systems, alarms, TVs, wearables, etc. While IoT devices enable new and efficient services, they also pose security threats (e.g., as witnessed in Mirai and Hajime attacks). A single vulnerability can affect a large number of homes/offices because a specific device might be deployed in large numbers. The number of manufacturers is large and volatile in this emerging market and some manufacturers do not last as long as their devices do. Accordingly, if a device is affected with by a malicious party after a manufacturer is no longer in business, security updates or recalls are not possible.

Often times, offices and homes might not be tracking the devices in their network, the way their communications evolve over time, the new vulnerabilities the devices expose, etc. This is propelled by the fact that unlike traditional computing systems, IoT devices are often left unattended-being setup once and subsequently left in place without proactive interaction with by the user directly. As the number of devices keeps growing, devices may remain in the network unattended by the users and admins, and even likely unpatched against known vulnerabilities, increasing the risk of being exploited by attackers, and consequently leading to larger damages.

There exists a need to detect anomalies in the behavior of IoT devices; it is also important to further detect and identify threats and attacks among these anomalies.

### SUMMARY

In one exemplary aspect, the techniques described herein relate to a method for detecting anomalous behavior in devices within a network, the method including: identifying, from a first plurality of packets intercepted in a network, a subset of packets corresponding to a first device of a plurality of devices in the network; extracting a plurality of deterministic features from the subset of packets; determining a deviation of the plurality of deterministic features from a deterministic profile of the first device, wherein the deterministic profile includes features representing a normal behavioral pattern of the first device; determining a first probability of anomalous behavior from the first device by inputting a first feature vector including device-specific traffic information generated from the subset of packets into a device anomaly detection artificial intelligence (AI) model of the first device; determining a second probability of anomalous behavior in the network by inputting the second feature vector including network-specific traffic information generated from the first plurality of packets into a network anomaly detection artificial intelligence (AI) model; calculating a risk score associated with the first device based on the deviation, the first probability, and the second probability; determining, using an attack classification model, an attack type of the first device, wherein the attack classification model is retrained based on analyst feedback; executing a remediation action based on the attack type to resolve anomalous behavior in the first device in response to determining that the risk score is greater than a threshold risk score.

In some aspects, the techniques described herein relate to a method, further including: determining, using an attack classification model, an attack type of the first device, wherein the attack classification model is configured to classify an anomaly vector into a respective attack type; and performing the remediation action based on the attack type.

In some aspects, the techniques described herein relate to a method, wherein the attack classification model is retrained based on analyst feedback provided by a security analyst. For example, the attack classification model may perform at a first accuracy level (91%). A security analyst may provide analyst feedback, which includes new data or corrected data that comprises the data from input vectors that were misclassified paired with the correct classification. By retraining the attack classification model, the accuracy of the attack classification model may rise from the first accuracy level to a second accuracy level (e.g., 95%)

In some aspects, the techniques described herein relate to a method, wherein the device anomaly detection AI model and the network anomaly detection AI model are retrained based on analyst feedback provided by a security analyst.

In some aspects, the techniques described herein relate to a method, further including: intercepting, during a training phase prior to intercepting the first plurality of packets, a second plurality of packets of the network over a period of time; identifying the plurality of devices in the network based on the second plurality of packets.

In some aspects, the techniques described herein relate to a method, further including: for each respective device of the plurality of devices: extracting deterministic features of the respective device from the second plurality of packets; generating a respective deterministic profile based on the extracted deterministic features of the respective device.

In some aspects, the techniques described herein relate to a method, wherein the extracted deterministic features of the respective device include one or more of: protocols used at different layers of a transmission control protocol (TCP) or internet protocol (IP) stack, domains resolved, domains contacted, transport layer security (TLS) fingerprints of servers contacted, TLS fingerprints of the respective device for different servers, headers of specific protocols (e.g., HTTP), etc.

In some aspects, the techniques described herein relate to a method, wherein the respective deterministic profile is a hash table including hash values representing the extracted deterministic features.

In some aspects, the techniques described herein relate to a method, further including: generating, for each respective device of the plurality of devices, a device-specific training dataset including a plurality of feature vectors using the second plurality of packets; training, for each respective device of the plurality of devices, a respective device anomaly detection AI model using the device-specific training dataset, wherein the respective device anomaly detection AI model is configured to classify an input feature vector as anomalous or non-anomalous and output an associated probability.

In some aspects, the techniques described herein relate to a method, further including: generating, for the network, a network-specific training dataset including a plurality of feature vectors using the second plurality of packets; training, for the network, the network anomaly detection AI model using the network-specific training dataset, wherein the network anomaly detection AI model is configured to classify an input feature vector as anomalous or non-anomalous and output an associated probability.

In some aspects, the techniques described herein relate to a method, wherein the first feature vector includes, for the first device, one or more of: a size of each packet, time intervals between packets, direction of the packets, semantic information of IP addresses and port numbers, statistical information of sizes pertaining to 5-tuple connections, etc.

In some aspects, the techniques described herein relate to a method, wherein the second feature vector includes, for the plurality of devices in the network, one or more of: a size of each packet, time intervals between packets, the direction of packets, semantic information of IP addresses and port numbers, etc.

In some aspects, the techniques described herein relate to a method, wherein the remediation action includes one or more of: factory resetting the first device, rebooting the first device, transmitting an alert about the anomalous behavior of the first device to a network administrator of the network, blocking of the traffic of the first device, re-routing of the traffic of the first device to a security middlebox, and removing the first device from the network.

It should be noted that the methods described above may be implemented in a system comprising a hardware processor. Alternatively, the methods may be implemented using computer executable instructions of a non-transitory computer readable medium.

In some aspects, the techniques described herein relate to a system for detecting anomalous behavior in devices within a network, including: a memory; and a hardware processor communicatively coupled with the memory and configured to: identify, from a first plurality of packets intercepted in a network, a subset of packets corresponding to a first device of a plurality of devices in the network; extract a plurality of deterministic features from the subset of packets; determine a deviation of the plurality of deterministic features from a deterministic profile of the first device, wherein the deterministic profile includes features representing a normal behavioral pattern of the first device; determine a first probability of anomalous behavior from the first device by inputting a first feature vector including device-specific traffic information generated from the subset of packets into a device anomaly detection artificial intelligence (AI) model of the first device; determine a second probability of anomalous behavior in the network by inputting the second feature vector including network-specific traffic information generated from the first plurality of packets into a network anomaly detection artificial intelligence (AI) model; calculate a risk score associated with the first device based on the deviation, the first probability, and the second probability; and execute a remediation action to resolve anomalous behavior in the first device in response to determining that the risk score is greater than a threshold risk score.

In some aspects, the techniques described herein relate to a non-transitory computer readable medium storing thereon computer executable instructions for detecting anomalous behavior in devices within a network, including instructions for: identifying, from a first plurality of packets intercepted in a network, a subset of packets corresponding to a first device of a plurality of devices in the network; extracting a plurality of deterministic features from the subset of packets; determining a deviation of the plurality of deterministic features from a deterministic profile of the first device, wherein the deterministic profile includes features representing a normal behavioral pattern of the first device; determining a first probability of anomalous behavior from the first device by inputting a first feature vector including device-specific traffic information generated from the subset of packets into a device anomaly detection artificial intelligence (AI) model of the first device; determining a second probability of anomalous behavior in the network by inputting the second feature vector including network-specific traffic information generated from the first plurality of packets into a network anomaly detection artificial intelligence (AI) model; calculating a risk score associated with the first device based on the deviation, the first probability, and the second probability; and executing a remediation action to resolve anomalous behavior in the first device in response to determining that the risk score is greater than a threshold risk score.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for detecting anomalous behavior in Internet-of-Things (IoT) devices.

FIG. 2 is a block diagram illustrating a method for generating deterministic and probabilistic profiles.

FIG. 3 is a block diagram illustrating a method for detecting anomalous behavior using the generated deterministic and probabilistic profiles.

FIG. 4 is a block diagram illustrating a method for computing a risk score.

FIG. 5 illustrates a flow diagram of a method for detecting anomalous behavior in IoT devices.

FIG. 6 presents an example of a general-purpose computer system on which aspects of the present disclosure can be implemented.

### DETAILED DESCRIPTION

Exemplary aspects are described herein in the context of a system, method, and computer program product for detecting vulnerabilities in Internet-of-Things (IoT) devices. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

To address the issues discussed in the background, the present disclosure describes detecting all IoT devices in a network and subsequently monitoring them for anomalous behavior and estimating associated risks. In an exemplary aspect, detecting anomalous behavior involves the use of three profiles generated based on communication traffic of IoT devices in a network: i) a per-device deterministic profile; ii) a per-device artificial intelligence (AI)-based anomaly detection model; iii) AI-based network anomaly detection model. While the first profile is deterministic, the remaining two are probabilistic profiles. The use of both deterministic and probabilistic profiles enhances the detection of strict and statistical deviations from learned profiles. Anomalies detected by these three models are input into another AI model that attempts to identify the type of the network attack. The system of the present disclosure ultimately helps in detecting both device-specific and network-wide anomalies.

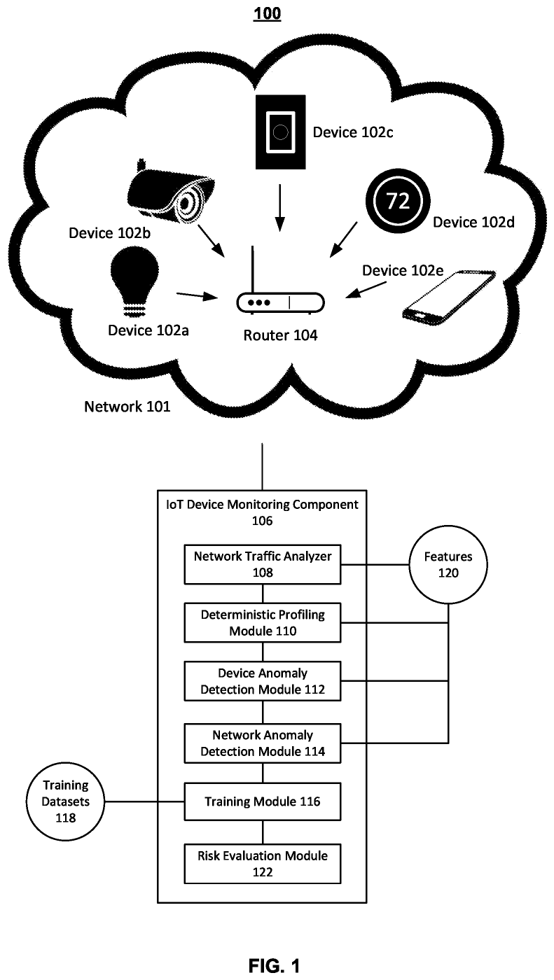

FIG. 1 is a block diagram illustrating system 100 for detecting vulnerabilities in Internet-of-Things (IoT) devices. System 100 includes network 101, which may include a plurality of IoT devices 102 installed in an office, a home, a factory, etc. Example IoT devices include a smart light (e.g., device 102a), a smart camera (e.g., device 102b), a smart switch (e.g., device 102c), a smart thermostat (e.g., device 102d), and a smartphone (e.g., device 102e). Each of the devices may be connected via a local area network (LAN) or a wide area network (WAN) such as the Internet. More specifically, each of the devices 102 may be connected to a Wi-Fi network via router 104. It should be noted that the size of network 101 and the number of connection points (e.g., routers) may vary. The limited number of devices and routers shown in FIG. 1 is for simplicity.

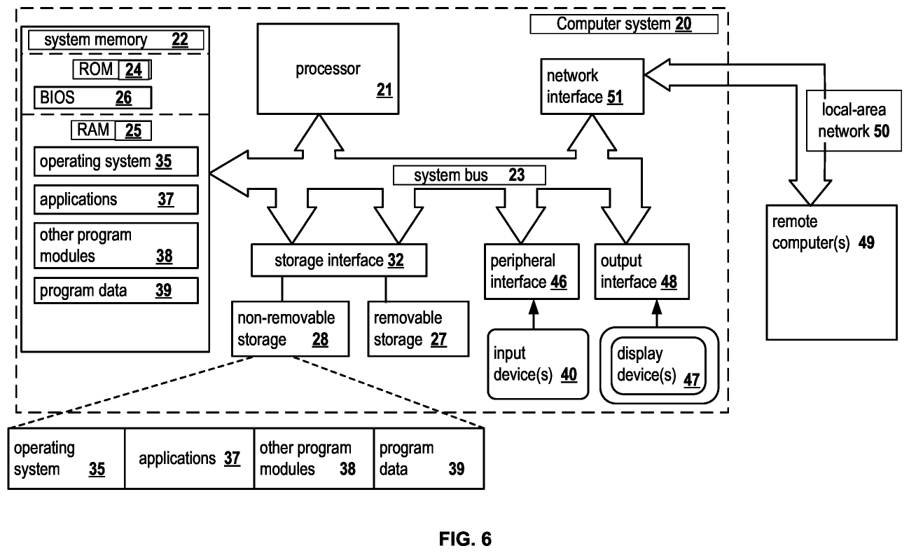

System 100 also includes IoT device monitoring component 106, which may be installed on a computer system (described in FIG. 6) that is connected to network 101. In general, IoT device monitoring component 106 learns normal network profiles of devices in network 101 using both deterministic approaches as well as AI models. To build profiles, IoT device monitoring component 106 uses a combination of network characteristics including, but not limited to, protocols used, headers of specific protocols of interest (e.g., HTTP), transport layer security (TLS) fingerprints of servers contacted, TLS fingerprints of client devices, etc. IoT device monitoring component 106 further learns to classify anomalies into attacks using few (or even zero) labeled data, and potentially with feedback from analysts.

IoT device monitoring component 106 includes network traffic analyzer 108, which may be a packet sniffing module that collects and processes features 120 comprising network information about network 101 and device communication information for each of devices 102. IoT device monitoring component 106 further includes deterministic profiling module 110, device anomaly detection module 112, network anomaly detection module 114, and risk evaluation module 116. Each of the AI models part of device anomaly detection module 112, network anomaly detection module 114, and risk evaluation module 122 may be trained by training module 116, which uses a plurality of training datasets 118.

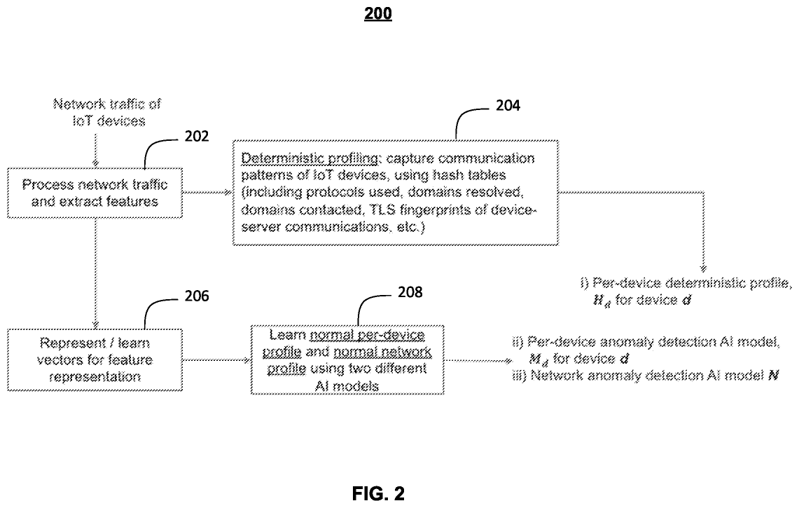

FIG. 2 is a block diagram illustrating method 200 for generating deterministic and probabilistic profiles. At 202, network traffic analyzer 108 processes network traffic of IoT devices 102 and extracts features 120. A subset of features 120 are used to generate a deterministic profile and another subset of features 120 is used to create training vectors for AI models.

At 204, deterministic profiling module 110 generates a deterministic profile for each device 102 in network 101. More specifically, for each device in network 101, deterministic profiling module 110 captures, over a period of time, the subset of features 120 comprising communication patterns of the device in a hash table. The communication patterns include, but are not limited to, the protocols used at different layers of the TCP/IP stack, domains resolved, domains contacted, headers of specific protocols of interest (e.g., HTTP), TLS fingerprints of servers contacted, TLS fingerprints of the device for different servers, etc. For example, the values of each of these patterns are mapped to a bucket in the hash table using a hash function.

Let Ha denote the deterministic profile for device d, which can be constructed using the hash table. In some aspects, network traffic analyzer 108 may store statistical measurements such as mean and standard deviation of network communications for a particular protocol of a device in the hash table. Because the hash table is populated over a period of time, network traffic analyzer 108 may also refine the values in the hash table over time as the traffic analyzed increases. In some aspects, there may be multiple periods of time during which the deterministic profiles are built, and the periods of time can be of fixed or variable length.

At 206, training module 116 transforms the network traffic collected in 202 into vectors. This can be achieved using any of the embedding algorithms in the deep learning domain, or by learning while training. The goal here is to transform raw network data into feature vectors, which serve as a good representation of network behavior. Features 120 may include raw network data such as details about network packets, the size of each packet, time intervals between packets, direction of packets, semantic information of IP addresses (e.g., internal/external) and port numbers (e.g., service port or not). In some aspects, the vectors are included in training datasets 118.

For example, IoT device monitoring component 106 may use a pre-trained AI model that can classify IoT devices into IoT categories (e.g., smartphone, smart camera, thermostat, etc.). IoT device monitoring component 106 may use latent embeddings or end-to-ending embeddings in this pre-trained AI model as network traffic features. Thus, a subset of features 120 (e.g., raw traffic data) gets fed into one model, which learns a feature representation. Then this output is fed into a second model (e.g., a Variational Auto-Encoder (VAE)), which learns to detect anomalies in an unsupervised way.

At 208, training module 116 trains an AI-based unsupervised device anomaly detection model of module 112. In some aspects, training module 116 may train an individual model for each device (e.g., an AutoEncoder (AE), a VAE, one-class support vector machine (SVM), application of dimensionality clustering followed by clustering, etc.) in network 101. In this case, let M_{d} for device d denote the per-device model. In other aspects, training module 116 may train one conditional model (e.g., a Conditional VAE) for all devices in network 101.

At 208, training module 116 may further train an AI-based unsupervised network anomaly detection model of module 114. This is achieved by training a VAE on the network traffic of all devices. Let N denote such a model. It should be noted that although the models are trained using traffic captured in a particular period of time, as with the building of the deterministic profiles, the models may be updated later as more traffic is collected.

It should also be noted that much of the communication in network 101 is clean/normal during this training phase. That is, there are no infected IoT devices. The cleaner the traffic, the better the model learning. In the event that a new device is added to network 101, a new per-device deterministic profile and anomaly model are constructed/trained for that device. Similarly, the network model is updated to include the traffic information of the new device in network 101.

In some aspects, the network characteristics used for profiling IoT devices may be expanded over time. Similarly, the attributes used to define an attack type can be augmented using information available from various sources (e.g., a threat intelligence database). The profiles created and revised may also be shared with a central server in a privacy-preserving manner to improve accuracy of anomaly detection.

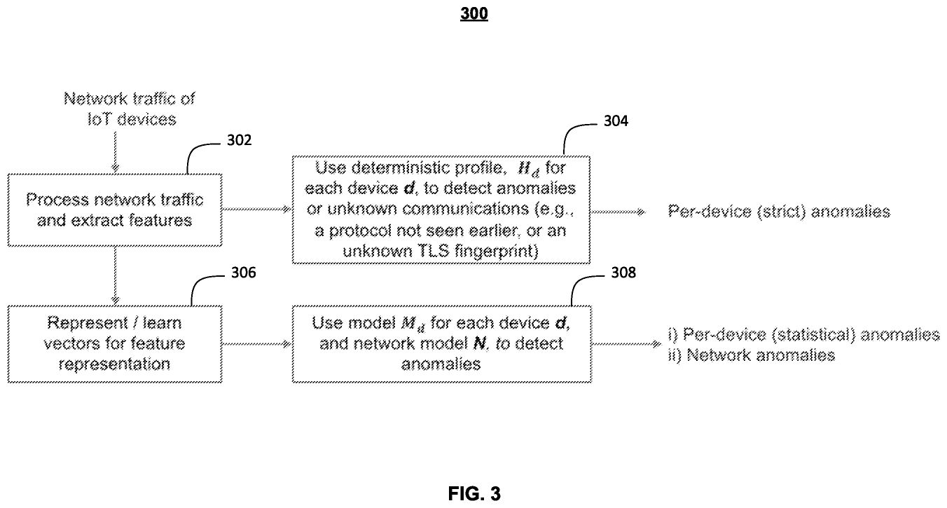

FIG. 3 is a block diagram illustrating method 300 for detecting anomalous behavior using the generated deterministic and probabilistic profiles. Method 300 is initiated once deterministic profiles and anomaly models for each network device in network 101 and the anomaly model for the entire network are created. At 302, network traffic analyzer 108 processes network traffic of IoT devices 102 and extract additional features 120.

At 304, deterministic profiling module 110 uses deterministic profile, Ha for each device d, to detect anomalies or unknown communications pertaining to device d. Examples of such anomalies include a protocol not seen in the deterministic profile learned during the training phase, a connection with size that deviates significantly from the deterministic profile, etc.

At 306, device anomaly detection module 112 transforms device-specific network traffic into a device-specific feature vector. Furthermore, network anomaly detection module 114 transforms network traffic into a network feature vector. The transformations may be achieved using any of the embedding algorithms in deep learning domain, or by learning while training.

At 308, IoT device monitoring component 106 executes model M_{d} for each device d, and network model N, to detect per-device anomalies and network anomalies, respectively.

Thus, during method 300, IoT device monitoring component 106 detects i) per-device behavioural deviations from deterministic profiles, ii) per-device statistical anomalies based on AI model M_{d} for each device d, and iii) network anomalies based on AI model N.

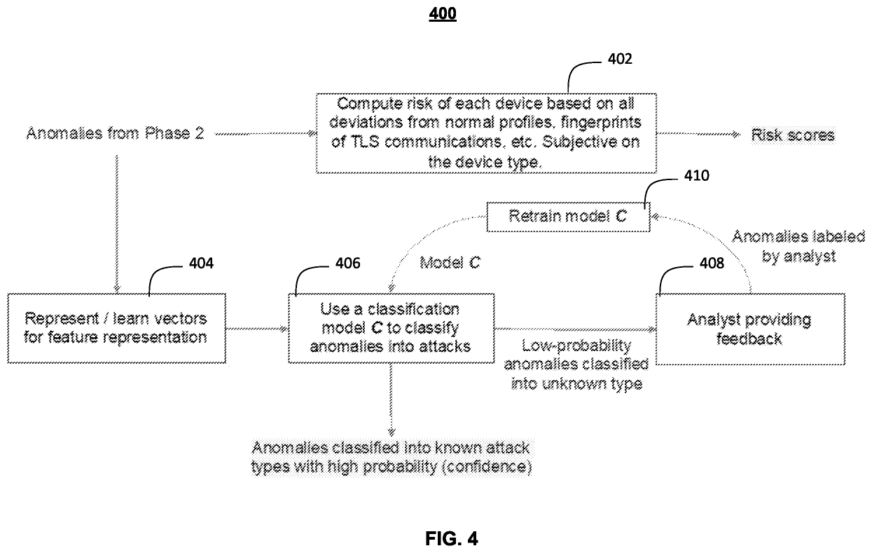

FIG. 4 is a block diagram illustrating method 400 for computing a risk score.

At 402, risk evaluation module 122 computes a risk score of each IoT device based on deviations from the normal deterministic profile of that device. An example of a risk scoring approach may involve, for each packet or flow or traffic session, checking if there is a deviation from the deterministic profile. For quantitative characteristics such as distribution of packet size, distribution of time interval between packets, etc., risk evaluation module 122 may measure a quantitative difference from the deterministic profile (e.g., by counting the number of standard deviations). Risk evaluation module 122 may then compute the percentage of packets or flows or traffic sessions which do not fit into the deterministic profile. A high percentage signifies a large risk score, and vice versa. In some aspects, the risk scoring algorithm of risk evaluation module 122 is a function of both the deviations from the deterministic profile and the vectors representing anomalies detected by the AI models.

At 404, risk evaluation module 122 embeds anomalies detected by the AI models associated with modules 110 and 112 using vectors. At 406, risk evaluation module 122 uses a classification model C to classify anomalies into attack classes. If the classification probability (e.g., confidence score) for an anomaly is lower than a predetermined threshold risk evaluation module 122 may send the data associated with the device to a security analyst for analysis. If the classification probability is now lower than the threshold, the anomaly is deemed to be an attack. At 408, training module 116 receives analyst feedback and at 410, retrains the model C using the received feedback. For example, the analyst feedback may be a conclusive verdict of whether an anomaly is an attack.

In general, classification model C can be trained in one of the following ways. First, C can be trained using reinforcement learning so as to continuously learn from analyst feedback. Second, C can also be trained using a few-shot or zero-shot learning (ZSL) approach, since it is not easy to continuously obtain labeled data. For ZSL approach, some examples of attacks relevant in the context of IoTs and their attributes are:

| Attack type | Attributes |
|---|---|
| C&C | Direction-out, multiple connections from the same |
| communications | device, application protocols such as HTTP(S) or |
| | DNS in use. |
| Scan from (to) | Direction-in (out), short numerous packets across IP |
| Internet | address range or port range |
| Low-rate attack | Direction-out (in), short connection/flows to single |
| from (to) devices | target |
| DDOS from (to) | Direction-out (in), large number of flows, potentially |
| devices | in high volumes. |

The attack data may also be augmented using a GAN (generative adversarial network) model.

In some aspects, the deterministic and AI-based profiles of a particular IoT device in one network may be checked against the same device type in other networks for deviations. Such deviations could also be considered anomalous. In some aspects, IoT device monitoring component 106 may apply a federated learning approach to learn the normal behavior of the same device type across multiple networks. This may help in improving the learning process as more data would be available from multiple networks. The centrally-learned model may then be deployed at the different networks, potentially by fine-tuning to the specific environment. Such a solution may also be privacy-sensitive, by only passing the parameters of the network traffic (or a local model) of a network to the central model.

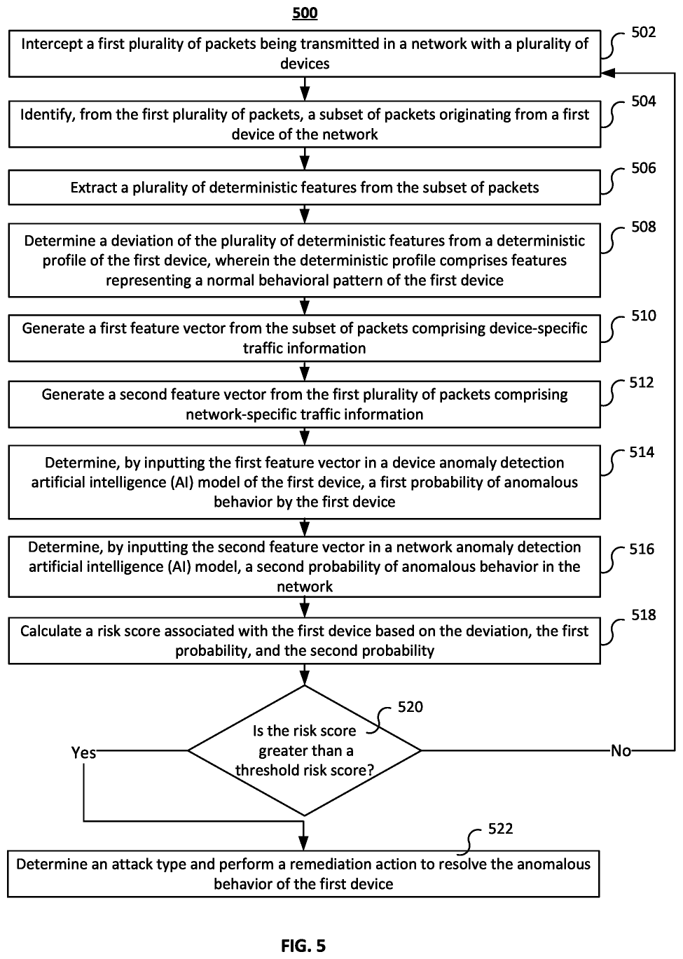

FIG. 5 illustrates a flow diagram of method 500 for detecting anomalous behavior in IoT devices. Prior to method 500, a training phase occurs. In this phase, device monitoring component 106 intercepts a plurality of packets of network 101 over a period of time (e.g., 24 hours). Based on the plurality of packets, device monitoring component 106 identifies the plurality of devices 102 in network 101. For example, device monitoring component 106 may be installed on a server that is connected to network 101. Device monitoring component 106 may be granted privileges from the administrator of network 101 to sniff packets in network 101 and identify all of the devices in network 101. In some aspects, device monitoring component 106 may transmit discovery messages to all devices 102 in network 101 and identify each device based on each received response to the discovery messages.

For each respective device of the plurality of devices 102 (e.g., device 102a, device 102b, etc.), device monitoring component 106 may extract deterministic features of the respective device from the plurality of packets. For example, device monitoring component 106 may group subsets of packets in the plurality of packets based on the source and destination IP addresses of the respective device. Using each grouped subset, device monitoring component 106 may extract deterministic features such as protocols used at different layers of a transmission control protocol (TCP) or internet protocol (IP) stack, domains resolved, domains contacted, headers of specific protocols of interest (e.g., HTTP), size/volume of certain common connections, transport layer security (TLS) fingerprints of servers contacted, TLS fingerprints of the respective device for different servers.

Device monitoring component 106 may then generate a respective deterministic profile based on the extracted deterministic features of the respective device. In some aspects, the respective deterministic profile is a hash table comprising hash values representing the extracted deterministic features. For example, each deterministic feature identified above may be inputted into a hashing algorithm and the output may be stored in the deterministic profile. Subsequently, when the respective device is evaluated at a later time (e.g., during method 500), the values in the deterministic profile may be compared against the deterministic features extracted at that time. In addition to generating a deterministic profile, device monitoring component 106 may generate, for each respective device of the plurality of devices 102, a device-specific training dataset (included in training datasets 118) comprising a plurality of feature vectors labelled by anomalous or non-anomalous classes using the plurality of packets. For example, a given training dataset may include device-specific information about device 102a. The feature vectors of that training dataset may include one or more features such as a size of each packet associated with the device, time intervals between transmitted/received packets, direction of packets, semantic information of IP addresses and port numbers, sizes of connections (e.g., using 5-tuple information of source/destination IP addresses, source/destination ports, protocol, etc. The feature vector may further be labelled as anomalous/non-anomalous, although this is not necessary for the proposed unsupervised approach.

Device monitoring component 106 may then train, for each respective device of the plurality of devices, a respective device anomaly detection AI model using the device-specific training dataset, wherein the respective device anomaly detection AI model is configured to classify an input feature vector as anomalous or non-anomalous and output an associated probability. For example, the device anomaly detection AI model may be specific to device 102a and may compare an input feature vector determined in method 500 to the given feature vectors described above. If the input feature vector matches more closely with the anomalous feature vectors, the input feature vector may be identified as anomalous as well. Furthermore, the device anomaly detection AI model may output a confidence score associated with the anomalous class. This confidence score is a probability of the device anomaly detection AI model being correct in its classification. This model is focused on the individual behavior of devices.

In addition to a device-specific model for each respective device in network 101, device monitoring component 106 may generate, for network 101, a network-specific training dataset (for inclusion in training datasets 118) comprising a plurality of feature vectors labelled by anomalous or non-anomalous classes using the plurality of packets. For example, the feature vectors for the network-specific training dataset may include features such as: a size of each packet transmitted in network 101, time intervals between transmitted/received packets for all devices in network 101, direction of packets, semantic information of IP addresses and port numbers for all devices in network 101, sizes of connections (e.g., using 5-tuple information of source/destination IP addresses, source/destination ports, protocol, etc. Device monitoring component 106 may then train, for network 101, a network anomaly detection AI model using the network-specific training dataset, wherein the network anomaly detection AI model is configured to classify an input feature vector as anomalous or non-anomalous and output an associated probability. Similar to the device anomaly detection AI model, the network anomaly detection AI model classifies an input feature vector as anomalous or non-anomalous and provides a confidence score of the classification. Unlike the device anomaly detection AI model, however, the network anomaly detection AI model has an input feature vector representing traffic information of all devices in network 101 (not just a specific device). This model is therefore better able to capture the interactions between devices and does not view a single device individually.

Method 500 begins when the training phase described above is complete.

At 502, device monitoring component 106 intercepts a first plurality of packets being transmitted in network 101 with the plurality of devices 102.

At 504, device monitoring component 106 identifies, from the first plurality of packets, a subset of packets corresponding to a first device of network 101. For example, the first device may be device 102a. For example, device monitoring component 106 may include packets transmitted and/or received by device 102a during a given period of time (e.g., 10 minutes) in the subset of packets.

At 506, device monitoring component 106 extracts a plurality of deterministic features from the subset of packets of device 102a. At 508, device monitoring component 106 determines a deviation of the plurality of deterministic features from a deterministic profile of device 102a, wherein the deterministic profile comprises features representing a normal behavioral pattern of device 102a. As mentioned before, for quantitative characteristics such as a distribution of packet size, a distribution of time interval between packets, etc., device monitoring component 106 may measure a quantitative difference from the deterministic profile. The deviation may be a function of quantitative differences from each deterministic feature. For example, the deviation may be 50% (i.e., a 50% difference from normal behavior features).

At 510, device monitoring component 106 generates a first feature vector from the subset of packets comprising device-specific traffic information of device 102a. At 512, device monitoring component 106 generates a second feature vector from the first plurality of packets comprising network-specific traffic information of all devices in network 101. At 514, device monitoring component 106 determines, by inputting the first feature vector in the device anomaly detection AI model of device 102a, a first probability of anomalous behavior by device 102a. For example, device anomaly detection AI model may classify that the first feature vector is anomalous and the first probability of the anomaly may be 75%.

At 516, device monitoring component 106 determines, by inputting the second feature vector in a network anomaly detection model, a second probability of anomalous behavior in network 101. For example, network anomaly detection AI model may classify that the second feature vector is anomalous and the second probability of the anomaly may be 85%.

At 518, device monitoring component 106 calculates a risk score associated with device 102a based on the deviation, the first probability, and the second probability. For example, the risk score may be a function of these three values. In some aspects, the risk score may be a normal average, a weighted average (where each value is weighted differently), or a median of the three values. For example, the values are 50%, 75%, and 85%, as described, the average (i.e., the risk score) is 70.

At 520, device monitoring component 106 determines if the risk score is greater than a preset threshold risk score (e.g., 65). In response to determining that the risk score is not greater than the threshold risk score, method 500 returns to 502, where device monitoring component 106 intercepts a new set of packets. In response to determining that the risk score is greater than the threshold risk score, method 500 advances to 522, where device monitoring component 106 determines, using an attack classification model, an attack type of the first device, and executes a remediation action based on the attack type to resolve anomalous behavior in device 102a.

In some aspects, the remediation action comprises one or more of: factory resetting device 102a, rebooting device 102a, transmitting an alert about the anomalous behavior of device 102a to a network administrator of network 101, blocking of the traffic of a device, re-routing of the traffic of a device to a security middlebox, and removing device 102a from network 101.

In some aspects, device monitoring component 106 may determine, using an attack classification model (e.g., C), an attack type of device 102a, wherein the attack classification model is configured to classify an anomaly vector into a respective attack type. At 522, device monitoring component 106 may perform the remediation action based on the attack type.

FIG. 6 is a block diagram illustrating a computer system 20 on which aspects of systems and methods for detecting vulnerabilities in IoT devices may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I2C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-5 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, cDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for detecting anomalous behavior in devices within a network, the method comprising:
identifying, from a first plurality of packets intercepted in a network, a subset of packets corresponding to a first device of a plurality of devices in the network;
extracting a plurality of deterministic features from the subset of packets;
determining a deviation of the plurality of deterministic features from a deterministic profile of the first device, wherein the deterministic profile comprises features representing a normal behavioral pattern of the first device;
determining a first probability of anomalous behavior from the first device by inputting a first feature vector comprising device-specific traffic information generated from the subset of packets into a device anomaly detection artificial intelligence (AI) model of the first device;
determining a second probability of anomalous behavior in the network by inputting the second feature vector comprising network-specific traffic information generated from the first plurality of packets into a network anomaly detection artificial intelligence (AI) model;
calculating a risk score associated with the first device based on the deviation, the first probability, and the second probability;
determining, using an attack classification model, an attack type of the first device, wherein the attack classification model is retrained based on analyst feedback; and
executing a remediation action based on the attack type to resolve anomalous behavior in the first device in response to determining that the risk score is greater than a threshold risk score.

2. The method of claim 1, further comprising wherein the attack classification model is configured to classify an anomaly vector into a respective attack type.

3. The method of claim 1, further comprising:
intercepting, during a training phase prior to intercepting the first plurality of packets, a second plurality of packets of the network over a period of time;
identifying the plurality of devices in the network based on the second plurality of packets.

4. The method of claim 3, further comprising:
for each respective device of the plurality of devices:
extracting deterministic features of the respective device from the second plurality of packets;
generating a respective deterministic profile based on the extracted deterministic features of the respective device.

5. The method of claim 4, wherein the extracted deterministic features of the respective device include one or more of: protocols used at different layers of a transmission control protocol (TCP) or internet protocol (IP) stack, domains resolved, domains contacted, headers of specific protocols of interest, transport layer security (TLS) fingerprints of servers contacted, TLS fingerprints of the respective device for different servers.

6. The method of claim 4, wherein the respective deterministic profile is a hash table comprising hash values representing the extracted deterministic features.

7. The method of claim 3, further comprising:
generating, for each respective device of the plurality of devices, a device-specific training dataset comprising a plurality of feature vectors using the second plurality of packets;
training, for each respective device of the plurality of devices, a respective device anomaly detection AI model using the device-specific training dataset, wherein the respective device anomaly detection AI model is configured to classify an input feature vector as anomalous or non-anomalous and output an associated probability.

8. The method of claim 3, further comprising:
generating, for the network, a network-specific training dataset comprising a plurality of feature vectors labelled by anomalous or non-anomalous classes using the second plurality of packets;
training, for the network, the network anomaly detection AI model using the network-specific training dataset, wherein the network anomaly detection AI model is configured to classify an input feature vector as anomalous or non-anomalous and output an associated probability.

9. The method of claim 1, wherein the first feature vector comprises, for the first device, one or more of: a size of each packet, time intervals between packets, direction of the packets, semantic information of IP addresses and port numbers, statistical information of sizes pertaining to 5-tuple connections.

10. The method of claim 1, wherein the second feature vector comprises, for the plurality of devices in the network, one or more of: a size of each packet, time intervals between packets, semantic information of IP addresses and port numbers.

11. The method of claim 1, wherein the remediation action comprises one or more of: factory resetting the first device, rebooting the first device, transmitting an alert about the anomalous behavior of the first device to a network administrator of the network, limiting the access to the network by the first device, blocking/re-directing traffic of the first device, and removing the first device from the network.

12. A system for detecting anomalous behavior in devices within a network, comprising:
a memory; and
a hardware processor communicatively coupled with the memory and configured to:
identify, from a first plurality of packets intercepted in a network, a subset of packets corresponding to a first device of a plurality of devices in the network;
extract a plurality of deterministic features from the subset of packets;
determine a deviation of the plurality of deterministic features from a deterministic profile of the first device, wherein the deterministic profile comprises features representing a normal behavioral pattern of the first device;
determine a first probability of anomalous behavior from the first device by inputting a first feature vector comprising device-specific traffic information generated from the subset of packets into a device anomaly detection artificial intelligence (AI) model of the first device;
determine a second probability of anomalous behavior in the network by inputting the second feature vector comprising network-specific traffic information generated from the first plurality of packets into a network anomaly detection artificial intelligence (AI) model;
calculate a risk score associated with the first device based on the deviation, the first probability, and the second probability;
determine, using an attack classification model, an attack type of the first device, wherein the attack classification model is retrained based on analyst feedback; and
execute a remediation action based on the attack type to resolve anomalous behavior in the first device in response to determining that the risk score is greater than a threshold risk score.

13. The system of claim 12, wherein the attack classification model is configured to classify an anomaly vector into a respective attack type.

14. The system of claim 12, wherein the hardware processor is further configured to:
intercept, during a training phase prior to intercepting the first plurality of packets, a second plurality of packets of the network over a period of time;
identify the plurality of devices in the network based on the second plurality of packets.

15. The system of claim 14, wherein the hardware processor is further configured to:
for each respective device of the plurality of devices:
extract deterministic features of the respective device from the second plurality of packets;
generate a respective deterministic profile based on the extracted deterministic features of the respective device.

16. The system of claim 15, wherein the extracted deterministic features of the respective device include one or more of: protocols used at different layers of a transmission control protocol (TCP) or internet protocol (IP) stack, domains resolved, domains contacted, headers of specific protocols of interest, transport layer security (TLS) fingerprints of servers contacted, TLS fingerprints of the respective device for different servers.

17. The system of claim 15, wherein the respective deterministic profile is a hash table comprising hash values representing the extracted deterministic features.

18. The system of claim 14, wherein the hardware processor is further configured to:
generate, for each respective device of the plurality of devices, a device-specific training dataset comprising a plurality of feature vectors using the second plurality of packets;
train, for each respective device of the plurality of devices, a respective device anomaly detection AI model using the device-specific training dataset, wherein the respective device anomaly detection AI model is configured to classify an input feature vector as anomalous or non-anomalous and output an associated probability.

19. The system of claim 14, wherein the hardware processor is further configured to:
generate, for the network, a network-specific training dataset comprising a plurality of feature vectors labelled using the second plurality of packets;
train, for the network, the network anomaly detection AI model using the network-specific training dataset, wherein the network anomaly detection AI model is configured to classify an input feature vector as anomalous or non-anomalous and output an associated probability.

20. A non-transitory computer readable medium storing thereon computer executable instructions for detecting anomalous behavior in devices within a network, including instructions for:
identifying, from a first plurality of packets intercepted in a network, a subset of packets corresponding to a first device of a plurality of devices in the network;
extracting a plurality of deterministic features from the subset of packets;
determining a deviation of the plurality of deterministic features from a deterministic profile of the first device, wherein the deterministic profile comprises features representing a normal behavioral pattern of the first device;
determining a first probability of anomalous behavior from the first device by inputting a first feature vector comprising device-specific traffic information generated from the subset of packets into a device anomaly detection artificial intelligence (AI) model of the first device;
determining a second probability of anomalous behavior in the network by inputting the second feature vector comprising network-specific traffic information generated from the first plurality of packets into a network anomaly detection artificial intelligence (AI) model;
calculating a risk score associated with the first device based on the deviation, the first probability, and the second probability;
determining, using an attack classification model, an attack type of the first device, wherein the attack classification model is retrained based on analyst feedback; and
executing a remediation action based on the attack type to resolve anomalous behavior in the first device in response to determining that the risk score is greater than a threshold risk score.
